(19) United States
(12) Patent Application Publication
(10) Pub. No.: US 2018/0356699 A1
(43) Pub. Date: Dec. 13, 2018

(54) ARRAY SUBSTRATE AND LIQUID CRYSTAL DISPLAY PANEL

(71) Applicant: SHENZHEN CHINA STAR OPTOELECTRONICS SEMICONDUCTOR DISPLAY TECHNOLOGY CO., LTD., Shenzhen (CN)

(72) Inventor: Sikun HAO, Shenzhen (CN)

(21) Appl. No.: 15/571,284

(22) PCT Filed: Mar. 17, 2017
(86) PCT No.: PCT/CN2017/077096

§ 371 Date: Nov. 2, 2017

(30) Foreign Application Priority Data
Feb. 24, 2017 (CN) 201710109723.9

(51) Int. Cl. G02F 1/1362

(52) U.S. Cl. CPC G02F 1/136286; G02F 1/133514

(57) ABSTRACT

An array substrate including scan lines and data lines is provided. Wherein each data line includes a plurality of sub-data lines. The sub-data lines surrounding one or two columns of sub-pixels form the data line, where one end of the sub-data lines is connected to the data line, and each of the sub-data lines forming two sides of the data line is connected to one column of the sub-pixels. Two sub-pixels of the same row connected to a same sub-data line are connected to different scan lines. To the array substrate in the present disclosure, one data line is divided into two sub-data lines which are connected to a column of pixels, respectively.

### BACKGROUND OF THE INVENTION

### 1. Field of the Invention

The present disclosure relates to the field of liquid crystal displays, and more particularly to an array substrate and a liquid crystal display panel.

### 2. Description of the Prior Art

Panel display apparatuses, such as liquid crystal displays (LCD) and organic light emitting diodes (OLED), have become mainstream products in recent markets.

A display panel is an important component of the panel display apparatus, such as LCDs and OLEDs. For LCDs, the liquid crystal display panel consists essentially of a color filter substrate, a thin transistor array substrate, and a liquid crystal layer arranged between two substrates. Operating principle of the LCD is controlling rotation of liquid crystal molecules in the liquid crystal layer by applying a drive voltage to two glass substrates, and bending light rays provided by back light units to generate an image.

As shown in FIG. 1, an existing display panel comprises a plurality of pixels 101, data lines 102, and scan lines 103. Generally, pixels in a row connect to one of the data lines 102 correspondingly. For such a driving architecture, the number of the data lines 102 is triple the scan lines 103. Thus, it needs more driver chips, which is in contrary to cost reduction of liquid crystal displays.

### SUMMARY OF THE INVENTION

The present disclosure provides an array substrate where one data line is divided into two sub-data lines, each of which is connected to a column of pixels. The number of the data lines and driver chips is reduced by half to solve the problem that there are too many data lines and driver chips, which goes against the cost reduction of liquid crystal displays.

To solve the above problem, the present disclosure provides a technical scheme as follows:

The present disclosure provides an array substrate, comprising: a substrate; scan lines, data lines, and pixel units disposed on a surface of the substrate;

each data line includes a plurality of sub-data lines, each pixel unit includes a plurality of sub-pixels;

the sub-data lines surrounding one or two columns of the sub-pixels form the data line, one end of each sub-data line is connected to an output end of the data line, each of the sub-data lines forming two sides of the sub-data line is connected to one column of the sub-pixels, and the sub-data line is connected to a side of each sub-pixel;

the sub-pixels in a same row correspond to two scan lines, and two sub-pixels of the same row connected to a same sub-data line are connected to different scan lines;

the sub-pixels in a same column have a same color.

According to a preferred embodiment of the present disclosure, each of the sub-data lines surrounding a column of the sub-pixels and two adjacent sub-data lines are separated from each other by a column of the sub-pixels.

According to a preferred embodiment of the present disclosure, each of the sub-data lines surrounding two columns of the sub-pixels and two adjacent sub-data lines partially overlap with each other, and two columns of the sub-pixels connected to the same sub-data line are separated from each other by a column of the sub-pixels.

According to a preferred embodiment of the present disclosure, the sub-pixels attached to a first side of the data line are connected to the scan line above the sub-pixels, the sub-pixels attached to a second side of the data line are connected to the scan line below the sub-pixels. The second side is opposite to the first side.

According to a preferred embodiment of the present disclosure, the sub-pixels attached to a first side of the data line are connected to the scan line below the sub-pixels, the sub-pixels attached to a second side of the data line are connected to the scan line above the sub-pixels. The second side is opposite to the first side.

The present disclosure provides another array substrate, comprising: a substrate; scan lines, data lines, and pixel units disposed on a surface of the substrate;

each data line includes a plurality of sub-data lines, each pixel unit includes a plurality of sub-pixels;

the sub-data lines surrounding one or two columns of the sub-pixels form the data line, one end of each sub-data line is connected to an output end of the data line, each of the sub-data lines forming two sides of the data line is connected to one column of the sub-pixels, and the sub-data line is connected to a side of each sub-pixel;

the sub-pixels in a same row correspond to two scan lines, and two sub-pixels of the same row connected to a same sub-data line are connected to different scan lines.

According to a preferred embodiment of the present disclosure, each of the sub-data lines surrounding a column of the sub-pixels and two adjacent sub-data lines are separated from each other by a column of the sub-pixels.

According to a preferred embodiment of the present disclosure, each of the sub-data lines surrounding two columns of the sub-pixels and two adjacent sub-data lines partially overlap with each other, and two columns of the sub-pixels, connected to the same sub-data line, are separated from each other by a column of the sub-pixels.

According to a preferred embodiment of the present disclosure, the sub-pixels attached to a first side of the data line are connected to the scan line above the sub-pixels, the sub-pixels attached to a second side of the data line are connected to the scan line below the sub-pixels. The second side is opposite to the first side.

According to a preferred embodiment of the present disclosure, the sub-pixels attached to a first side of the data line are connected to the scan line below the sub-pixels, the sub-pixels attached to a second side of the data line are connected to the scan line above the sub-pixels. The second side is opposite to the first side.

According to the objective above, a liquid crystal display panel is provided, comprising:

an array substrate;

a color film substrate, arranged relative to the array substrate;

a liquid crystal layer, arranged between the array substrate and the color film substrate;

the array substrate includes a substrate; scan lines, data lines, and pixel units disposed on a surface of the substrate;

each data line includes a plurality of sub-data lines, each pixel unit includes a plurality of sub-pixels;

the sub-data lines surrounding one or two columns of the sub-pixels form the data line, one end of each sub-data lines is connected to an output end of the data line, each of the sub-data lines forming two sides of the data lines is connected to one column of the sub-pixels, and the sub-data line is connected to a side of each sub-pixel;

the sub-pixels in a same row correspond to two scan lines, and two sub-pixels of the same row connected to a same sub-data line are connected to different scan lines.

According to a preferred embodiment of the present disclosure, each of the sub-data lines surrounding a column of the sub-pixels and two adjacent sub-data lines are separated from each other by a column of the sub-pixels.

According to a preferred embodiment of the present disclosure, each of the sub-data lines surrounding two columns of the sub-pixels and two adjacent sub-data lines s partially overlap with each other, and two columns of the sub-pixels, connected to the same sub-data line, are separated from each other by a column of the sub-pixels.

According to a preferred embodiment of the present disclosure, the sub-pixels attached to a first side of the data line are connected to the scan line above the sub-pixels, the sub-pixels attached to a second side of the data line are connected to the scan line below the sub-pixels. The second side is opposite to the first side.

According to a preferred embodiment of the present disclosure, the sub-pixels attached to a first side of the data line are connected to the scan line below the sub-pixels, the sub-pixels attached to a second side of the data line are connected to the scan line above the sub-pixels. The second side is opposite to the first side.

According to a preferred embodiment of the present disclosure, the sub-pixels in a same column have a same color.

The present disclosure has the following beneficial effects: compared with the prior art, the present disclosure provides an array substrate where one data line is divided into two sub-data lines, each of which is connected to a column of pixels. The number of the data lines and driver chips is reduced by half to solve the problem that too many data lines and driver chips going against the cost reduction of liquid crystal displays.

### BRIEF DESCRIPTION OF THE DRAWINGS

In order to more clearly illustrate the technical solution in the present disclosure or in the prior art, the following will illustrate the figures used for describing the embodiments or the prior art. It is obvious that the following figures are only some embodiments of the present disclosure. For a person of ordinary skill in the art, without creative effort, other figures can also be obtained according to these figures.

FIG. 1 is a structural diagram of the existing array substrate.

FIG. 2 is a structural diagram of array substrate according to a first embodiment of the present disclosure.

FIG. 3 is a structural diagram of array substrate according to a second embodiment of the present disclosure.

FIG. 4 is a signal waveform diagram of array substrate according to a preferred embodiment of the present disclosure.

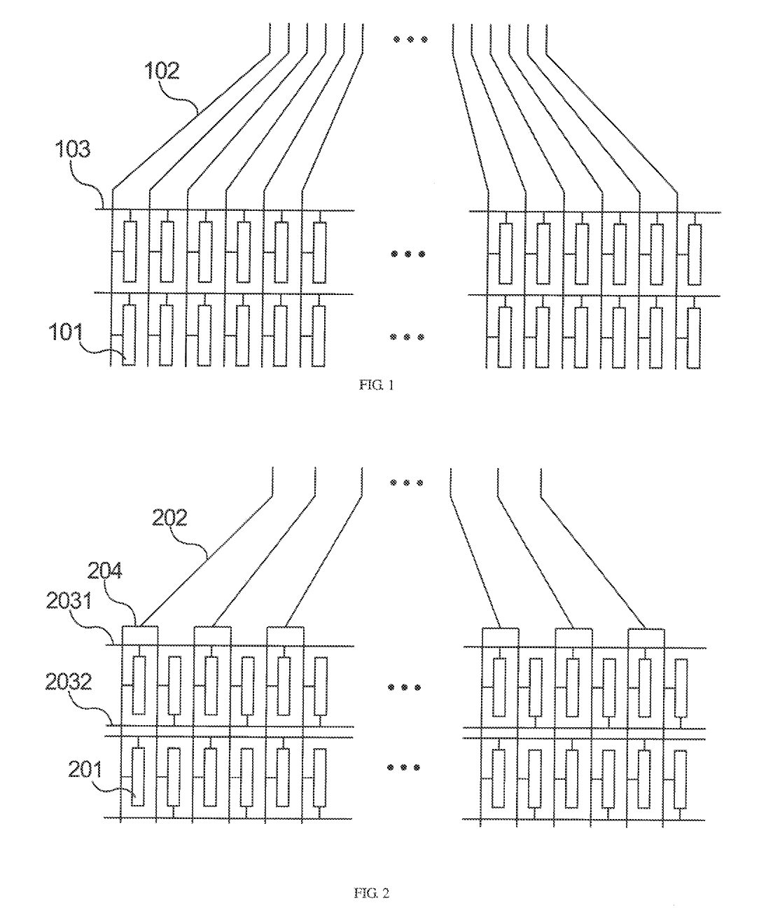

### DETAILED DESCRIPTION OF THE PREFERRED EMBODIMENTS

The following description of every embodiment with reference to the accompanying drawings is used to exemplify a specific embodiment which may be carried out in the present disclosure. Directional terms mentioned in the present disclosure, such as “top”, “bottom”, “front”, “back”, “left”, “right”, “inside”, “outside”, “side” etc., are only used with reference to the orientation of the accompanying drawings. Therefore, the used directional terms are intended to illustrate, but not to limit, the present disclosure. In the accompanying drawings, units with similar structures are indicated by the same sign.

For a pixel unit of an existing display panel in the present disclosure, pixels in a row connect to a data line correspondingly. For such a driving architecture, the number of the data lines is triple the scan lines So it needs more driver chips, going against the cost reduction of liquid crystal displays, but the present disclosure can overcome the defects of the prior art.

The present disclosure provides an array substrate, comprising: a substrate, scan lines, data lines, and pixel units. Wherein each data line includes a plurality of sub-data lines, each pixel unit includes a plurality of sub-pixels. The scan lines, the data lines, and the pixel units are disposed on a surface of the substrate. The sub-data lines surrounding one or two columns of the sub-pixels form the data line. One end of each sub-data line is connected to an output end of the data line. Each of the sub-data lines forming two sides of the data line is connected to one column of the sub-pixels, and the sub-data line is connected to a side of each sub-pixel. The sub-pixels in a same row correspond to two scan lines, and two sub-pixels of the same row connected to a same sub-data line are connected to different scan lines.

The sub-data line of the data line makes the data line to transmit data signals to two rows of pixels, and then reduces the number of data lines and driver chips, to cut down the cost of liquid crystal displays.

### One Preferred Embodiment

FIG. 2 is a structural diagram of an array substrate according to an embodiment of the present disclosure.

As shown in FIG. 2, it shows pixels of an array substrate according to an embodiment of the present disclosure. The array substrate comprises sub-pixels 201, data lines 202 including a plurality of sub-data lines 204 and scan lines 203. An input end of the data line 202 is connected to a driver chips, and an output end of the data line 202 is connected to the sub-data lines 204. Pixels in a row correspond to two scan lines, including a first scan line 2031 and a second scan line 2032 which are arranged to two sides of the pixels in a row, and two adjacent sub-pixels in the same row are connected to different scan lines.

A sub-data line 204 surrounding one column of sub-pixels 201 forms a data line 202, where two sides connect to a column of sub-pixels 201 respectively, and two adjacent columns of sub-pixels 201 are connected to the same data line 202. A junction of data line 202 and sub-pixel 201 is located on a side of sub-pixel 201, and two adjacent data lines 202 are separated from each other by a column of sub-pixels 201. For example, the sub-pixels 201 attached to a first side of the data line 202 are connected to the second scan line 2032, the sub-pixels 201 attached to a second side of the data lines 202 are connected to the first scan line 2031. In another example, the sub-pixels 201 attached to a first side of the data line 202 are connected to the first scan line 2031, the sub-pixels 201 attached to a second side of the data lines 202 are connected to the second scan line 2032. The first side is arranged relative to the second side.

Driving the array substrate above, and charging two columns of sub-pixels at the same time by connecting the data line 202 to the sub-data line. A target pixel of the sub-pixels in two columns is opened by the corresponding scan line to charge the target pixel. A data line 202 can charge two columns of sub-pixels, cutting down the number of data lines 202 by half, and reducing space of the data lines 202.

### Another Preferred Embodiment

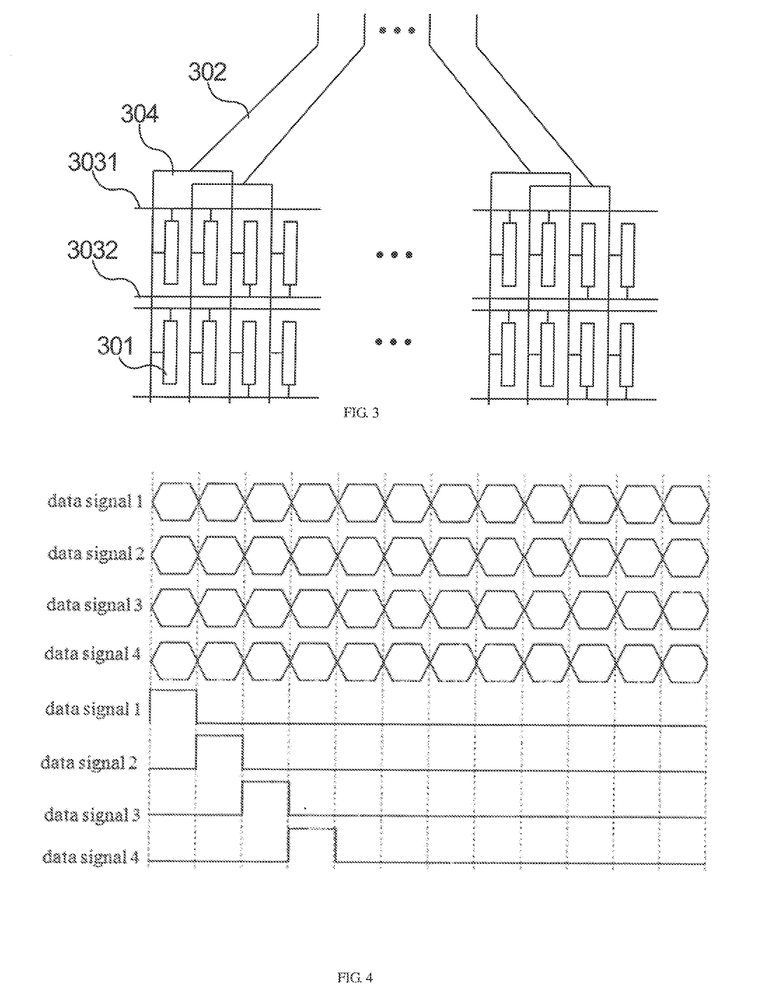

FIG. 3 is a structural diagram of an array substrate according to an embodiment of the present disclosure.

As shown in FIG. 3, it shows pixels of the array substrate according to an embodiment of the present disclosure. The array substrate comprises sub-pixels 301, data lines 302 including a plurality of sub-data lines 304 and scan lines 303. An input end of the data line 302 is connected to a driver chips, and an output end of the data line 302 is connected to the sub-data lines 304. Pixels in a row correspond to two scan lines, including a first scan line 3031 and a second scan line 2032, which are arranged to two sides of the pixels in a row and two adjacent sub-pixels in the same row are connected to different scan lines.

A sub-data line 304 surrounding two columns of sub-pixels 301 forms a data line, where two sides connect to a column of sub-pixels 301 respectively, and two adjacent data lines are crossed mutually. Two sides of the data line connect to a column of sub-pixels 301 respectively. Two columns of sub-pixels 301 connected to the same data line are separated from each other by a column of sub-pixels 301 which are connected to an adjacent data line. For example, the sub-pixels 301 attached to a first side of the data line 302 are connected to the second scan line 3032, the sub-pixels 301 attached to a second side of the data lines 302 are connected to the first scan line 3031. In another example, the sub-pixels 301 attached to a first side of the data line 302 are connected to the first scan line 3031, the sub-pixels 301 attached to a second side of the data lines 302 are connected to the second scan line 3032. The first side is arranged relative to the second side.

Driving the array substrate above, and charging two columns of sub-pixels at the same time by connecting a data line 302 to the sub-data line. A target pixel of sub-pixels in two columns is opened by the corresponding scan line to charge the target pixel. A data line 302 can charge two columns of sub-pixels, cutting down the number of data lines 302 by half, and reducing the space of the data lines 302.

For one preferred embodiment and another preferred embodiment, the junction of the sub-data line and the sub-pixel corresponding to the sub-data line is on a specific side of the pixel, which can apply to the situation that source electrode of thin film transistor in the pixel should be arranged to a specific side of the pixel. When there is no limit to the junction for the pixel, it can also apply to the following scheme: the sub-data line surrounding two columns of sub-pixels forms the data line, where two sides are connected to a column of pixels respectively; and there are no junctions between two adjacent data lines. Two columns of sub-pixels connected to the same data line are continuation columns. One side of the data line is connected to the same side of the sub-pixel, and so is the other side.

The drive method of that preferred embodiment is the same with the preferred embodiment above, which also brings the beneficial effects of reducing the number of data lines and driver chips.

According to the purpose of the present disclosure given above, an array substrate is provided, comprising: a substrate, scan lines, data lines, and pixel units. Wherein each data line includes a plurality of sub-data lines, each pixel unit includes a plurality of sub-pixels. The scan lines, the data lines, and the pixel units are disposed on a surface of the substrate. The sub-data lines surrounding one or two columns of sub-pixels form the data line. One end of each sub-data line is connected to an output end of the data line. Each of the sub-data lines forming two sides of the data line is connected to one column of the sub-pixels, and the sub-data line is connected to a side of each sub-pixel. The sub-pixels in a same row correspond to two scan lines, and two sub-pixels of the same row connected to a same sub-data line are connected to different scan lines.

The operating principle of the liquid crystal display panel according to the preferred embodiment is the same as the array substrate according to the preferred embodiment above. Please refer to the operating principle of the array substrate according to the preferred embodiment above. It is not reiterated here.

The present disclosure has the following beneficial effects: compared to the existing array substrate, the array substrate of the present disclosure divides one data line into two sub-data lines, where each sub-data line is connected to a column of pixels, to cut the number of the data lines and driver chips by half and then to solve the problem that too many data lines and driver chips lead to a higher cost for liquid crystal displays.

FIG. 4 is a signal waveform diagram of array substrate according to a preferred embodiment of the present disclosure. As shown in FIG. 4, data signal 1 to data signal 4 are transmitted over a data line, and scan signal 1 to signal 4 are transmitted over a scan line.

The present disclosure has the beneficial effects as follows: compared with the prior art, the present disclosure provides an array substrate where one data line is divided into two sub-data lines, each of which is connected to a column of pixels. The number of the data lines and driver chips is reduced by half to solve the problem that too many data lines and driver chips are against the cost reduction of liquid crystal displays.

The present disclosure is described in detail in accordance with the above contents with the specific preferred examples. However, this present disclosure is not limited to the specific examples. For a person of ordinary skill in the art, on the premise of keeping the conception of the present disclosure, the technical personnel can also make simple deductions or replacements, all of which should be considered to belong to the protection scope of the present disclosure.

What is claimed is:

1. An array substrate, comprising:
a substrate;
scan lines, data lines, and pixel units disposed on a surface of the substrate;
wherein each data line includes a plurality of sub-data lines, each pixel unit includes a plurality of sub-pixels;
wherein the sub-data lines surrounding one or two columns of the sub-pixels form the data line, one end of each sub-data line is connected to an output end of the data line, each of the sub-data lines forming two sides of the data line is connected to one column of the sub-pixels, and the sub-data line is connected to a side of each sub-pixel;
wherein the sub-pixels in a same row correspond to two scan lines, and two sub-pixels of the same row connected to a same sub-data line are connected to different scan lines;
wherein the sub-pixels in a same column have a same color.

2. The array substrate as claimed in claim 1, wherein each of the sub-data lines surrounding a column of the sub-pixels and two adjacent sub-data lines are separated from each other by a column of the sub-pixels.

3. The array substrate as claimed in claim 1, wherein each of the sub-data lines surrounding two columns of the sub-pixels and two adjacent sub-data lines partially overlap with each other, and two columns of the sub-pixels connected to the same sub-data line are separated from each other by a column of the sub-pixels.

4. The array substrate as claimed in claim 2, wherein the sub-pixels attached to a first side of the data line are connected to the scan line above the sub-pixels, the sub-pixels attached to a second side of the data line are connected to the scan line below the sub-pixels, the second side is opposite to the first side.

5. The array substrate as claimed in claim 2, wherein the sub-pixels attached to a first side of the data line are connected to the scan line below the sub-pixels, the sub-pixels attached to a second side of the data line are connected to the scan line above the sub-pixels, the second side is opposite to the first side.

6. An array substrate, comprising:
a substrate;
scan lines, data lines, and pixel units disposed on a surface of the substrate;
wherein each data line includes a plurality of sub-data lines, each pixel unit includes a plurality of sub-pixels;
wherein the sub-data lines surrounding one or two columns of the sub-pixels form the data line, one end of each sub-data line is connected to an output end of the data line, each of the sub-data lines forming two sides of the data line is connected to one column of the sub-pixels, and the sub-data line is connected to a side of each sub-pixel;
wherein the sub-pixels in a same row correspond to two scan lines, and two sub-pixels of the same row connected to a same sub-data line are connected to different scan lines.

7. The array substrate as claimed in claim 6, each of the sub-data lines surrounding a column of the sub-pixels and two adjacent sub-data lines are separated from each other by a column of the sub-pixels.

8. The array substrate as claimed in claim 6, each of the sub-data lines surrounding two columns of the sub-pixels and two adjacent sub-data lines partially overlap with each other, and two columns of the sub-pixels, connected to the same sub-data line, are separated from each other by a column of the sub-pixels.

9. The array substrate as claimed in claim 7, wherein the sub-pixels attached to a first side of the data line are connected to the scan line above the sub-pixels, the sub-pixels attached to a second side of the data line are connected to the scan line below the sub-pixels, the second side is opposite to the first side.

10. The array substrate as claimed in claim 7, wherein the sub-pixels attached to a first side of the data line are connected to the scan line below the sub-pixels, the sub-pixels attached to a second side of the data line are connected to the scan line above the sub-pixels, the second side is opposite to the first side.

11. A liquid crystal display panel, comprising:
an array substrate;
a color film substrate, arranged relative to the array substrate;
a liquid crystal layer, arranged between the array substrate and the color film substrate;
wherein the array substrate includes a substrate;
scan lines, data lines, and pixel units disposed on a surface of the substrate;
wherein each data line includes a plurality of sub-data lines, each pixel unit includes a plurality of sub-pixels;
wherein the sub-data lines surrounding one or two columns of the sub-pixels form the data line, one end of each sub-data line is connected to an output end of the data line, each of the sub-data lines forming two sides of the data line is connected to one column of the sub-pixels, and the sub-data line is connected to a side of each sub-pixel;
wherein the sub-pixels in a same row correspond to two scan lines, and two sub-pixels of the same row connected to a same sub-data line are connected to different scan lines;

12. The array substrate as claimed in claim 11, wherein each of the sub-data lines surrounding a column of the sub-pixels and two adjacent sub-data lines are separated from each other by a column of the sub-pixels.

13. The array substrate as claimed in claim 11,
wherein each of the sub-data lines surrounding two columns of the sub-pixels and two adjacent sub-data lines partially overlap with each other, and two columns of the sub-pixels connected to the same sub-data line are separated from each other by a column of the sub-pixels.

14. The array substrate as claimed in claim 12, wherein the sub-pixels attached to a first side of the data line are connected to the scan line above the sub-pixels, the sub-pixels attached to a second side of the data line are connected to the scan line below the sub-pixels, the second side is opposite to the first side.
